(19) United States
(12) Patent Application Publication
(10) Pub. No.: US 2016/0082815 A1
(43) Pub. Date: Mar. 24, 2016

(54) GULL WING DOOR WITH SLIDE DOOR FOR VEHICLE

(71) Applicant: Hyundai Motor Company, Seoul (KR)

(72) Inventors: Ju Hyuck LEE, Hwaseong-si (KR); Ja Yong KOO, Seoul (KR); Ye Seul KIM, Hwaseong-si (KR); Yong Seok JANG, Hwaseong-si (KR); Hui Jung KIM, Seoul (KR); Min Su KANG, Siheung-si (KR); Seung Jun LEE, lncheon (KR)

(73) Assignee: Hyundai Motor Company, Seoul (KR)

(21) Appl. No.: 14/826,375

(22) Filed: Aug. 14, 2015

(30) Foreign Application Priority Data
Sep. 23, 2014 (KR) 10-2014-0126526

(51) Int. Cl. B60J 5/04; B60J 5/06

(52) U.S. Cl. CPC B60J 5/0486; B60J 5/0473; B60J 5/06

(57) ABSTRACT

A gull wing door with a slide door for a vehicle may include a gull wing door including an upper rail, a lower rail, and an intermediate rail in line at an upper end portion, a lower end portion, and an intermediate portion in a horizontal length direction and supported on a vehicle body by a hinge portion positioned at the upper end portion and openable/closable in a vertical direction about the hinge portion, and a slide door including upper and lower portions and an intermediate portion of the gull wing door at an upper end portion and a lower end portion, and a middle portion and openable/closable in a horizontal direction while being supported on the gull wing door by upper and lower rollers and an intermediate roller assembly.

### CROSS-REFERENCE TO RELATED APPLICATION

The present application claims priority to Korean Patent Application No. 10-2014-0126526 filed Sep. 23, 2014, the entire contents of which is incorporated herein for all purposes by this reference.

### BACKGROUND OF THE INVENTION

1. Field of the Invention

The present invention relates to a gull wing door with a slide door for a vehicle, which can be used as the slide door and be opened and closed even as the gull wing door.

2. Description of Related Art

For recent 2 to 3 years, camping population has rapidly increased, reaching numbers of one million people, and a market scale of camping goods has increased correspondingly

Camping has evolved from a level of just sleeping outdoors to include a step of taking a rest outdoors, and therefore, camping equipment has also continuously evolved.

Further, in recent years, nationwide auto camping sites or various camping facilities have rapidly increased, and as a result, an environment in which more people can conveniently enjoy the camping has been created and propagation of various travel related programs, people who intend to enjoy leisure with a family, and people who intend to enjoy nature have increased. Therefore, a continuous increase of camping groups is anticipated even in the future.

As the people who intend to enjoy the camping have increased, popularity of a recreational vehicle (RV) has increased.

The RV as a vehicle for leisure, is larger in loading space and interior space than a general sedan, and has an advantage in that the RV can be used for various purposes such as camping and leisure.

However, since equipment for enjoying camping or outdoor sports is numerous and varied, the loading space is insufficient, therefore a camping caravan (having more space) that costs much higher in price is additionally purchased in frequency.

If a door of the RV is largely opened like a wing body of a truck, the sense of openness can be significantly increased at the time of loading or unloading a large freight on or from the vehicle.

However, since a gull wing door is hard and inconvenient to open, the gull wing door is low in efficiency related with usage of the door in that it is cumbersome and inconvenient to use the gull wing door at the time of getting on or off the vehicle.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a gull wing door with a slide door for a vehicle that implements a new type of door acquired by combining the slide door which can be opened and closed in a slide scheme and the gull wing door which can be opened and closed in a gull wing scheme to be selected and used appropriately as necessary by using advantages of two doors of using the slide door when the gull wing door is closed, and opening and closing the gull wing door while closing the slide door.

According to various aspects of the present invention, a gull wing door with a slide door for a vehicle may include a gull wing door including an upper rail, a lower rail, and an intermediate rail in line at an upper end portion, a lower end portion, and an intermediate portion in a horizontal length direction and supported on a vehicle body by a hinge portion positioned at the upper end portion and openable/closable in a vertical direction about the hinge portion, and a slide door including upper and lower portions and an intermediate portion of the gull wing door at an upper end portion and a lower end portion, and a middle portion and openable/closable in a horizontal direction while being supported on the gull wing door by upper and lower rollers and an intermediate roller assembly.

The upper rail provided in the gull wing door may be configured to be deployed in line in a longitudinal direction along an inside of the upper end portion of the door, the lower rail may be configured to be deployed in line in the longitudinal direction along an inside of the lower end portion of the door, and the intermediate rail may be configured to be deployed in line in the longitudinal direction along an outside of the intermediate portion of the door.

The upper roller assembly provided in the slide door may include an upper fixed bracket fixed to the slide door, an upper roller arm, in which a rear end portion is rotatably supported on the upper fixed bracket by an upper hinge pin, and an upper roller configured to roll along the upper rail while being mounted on a front end portion of the upper roller arm.

The lower roller assembly provided in the slide door may include a lower fixed bracket fixed to the slide door, a lower roller arm, in which a rear end portion is rotatably supported on the lower fixed bracket by a lower hinge pin, a lower roller link member rotatably supported on a front end portion of the lower roller arm by a lower second hinge pin, and a plurality of lower rollers configured to roll along the lower rail while being mounted on the lower roller link member.

The lower roller assembly may further include a lower spring in which both ends are supported on a lower roller arm and the lower roller link member while surrounding the second hinge pin to elastically support the entirety of the lower roller link member including the lower roller.

The intermediate roller assembly provided in the slide door may include an intermediate fixed bracket fixed to the slide door, an intermediate roller arm, in which a rear end portion may be rotatably supported on the intermediate fixed bracket by an intermediate hinge pin, and a plurality of intermediate rollers that may be configured to roll along the intermediate rail while being mounted on a front end portion of the intermediate roller arm.

The intermediate roller assembly may further include an intermediate spring in which both ends may be supported the intermediate fixed bracket and the intermediate roller arm while surrounding the intermediate hinge pin to elastically support the entirety of the intermediate roller arm including the intermediate roller.

The gull wing door with the slide door according to the present invention has the following advantages.

First, since the gull wing door with the slide door can be used as the gull wing door as well as the slide door by deviating from one opening/closing scheme, disadvantages of two doors can be overcome and the door can be selected and used as necessary.

Second, since the slide door does not occupy a large space, there is a small spatial limit.

It is understood that the term “vehicle” or “vehicular” or other similar terms as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen-powered vehicles and other alternative fuel vehicles (e.g., fuel derived from resources other than petroleum). As referred to herein, a hybrid vehicle is a vehicle that has two or more sources of power, for example, both gasoline-powered and electric-powered vehicles.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1, FIG. 2, and FIG. 3 are perspective views illustrating an exemplary gull wing door with a slide door according to the present invention.

FIG. 4A and FIG. 4B are perspective views illustrating a hinge portion of the gull wing door in the exemplary gull wing door with the slide door according to the present invention.

FIG. 5A and FIG. 5B are perspective views illustrating an upper roller assembly of the slide door in the exemplary gull wing door with the slide door according to the present invention.

FIG. 6A and FIG. 6B are perspective views illustrating an intermediate roller assembly of the slide door in the exemplary gull wing door with the slide door according to the present invention.

FIG. 7A and FIG. 7B are perspective views illustrating a lower roller assembly of the slide door in the exemplary gull wing door with the slide door according to the present invention.

FIG. 8 is a plan view illustrating an operational state of the lower roller assembly of the slide door in the exemplary gull wing door with the slide door according to the present invention.

FIG. 9A and FIG. 9B are perspective views illustrating an application example of the exemplary gull wing door with the slide door according to the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

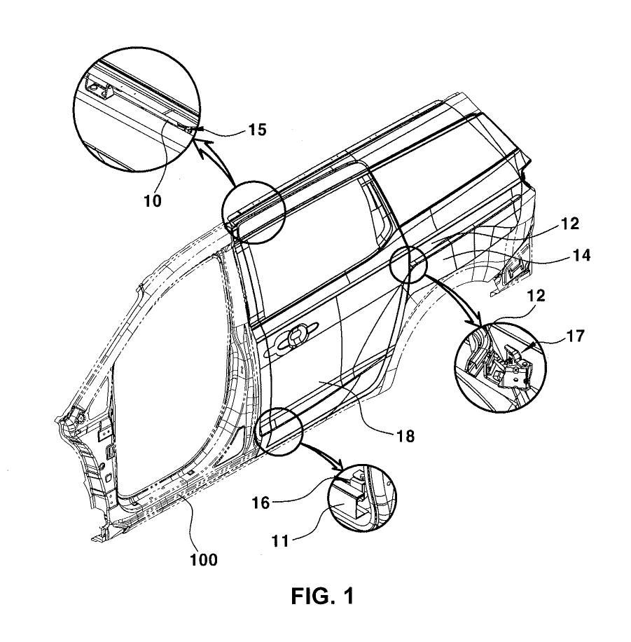

FIG. 1 to FIG. 3 are perspective views illustrating a gull wing door with a slide door according to various embodiments of the present invention.

As illustrated in FIG. 1 to FIG. 3, the gull wing door with the slide door is configured in a combination type of a gull wing door 14 which may be opened/closed in a gull wing scheme and a slide door 18 which may be opened/closed in a slide scheme and configured to be selectively opened/closed selectively according to a circumstance and conveniently used at the time of getting on or off or at the time of loading a burden.

The gull wing door 14 as a door opened/closed in a vertical direction is installed in a structure in which approximately both portions of an upper end portion are supported on a vehicle body 100 via a hinge portion 13.

As a result, the gull wing door 14 may be opened/closed in the vertical direction while rotating around the hinge portion 13 at the upper end portion.

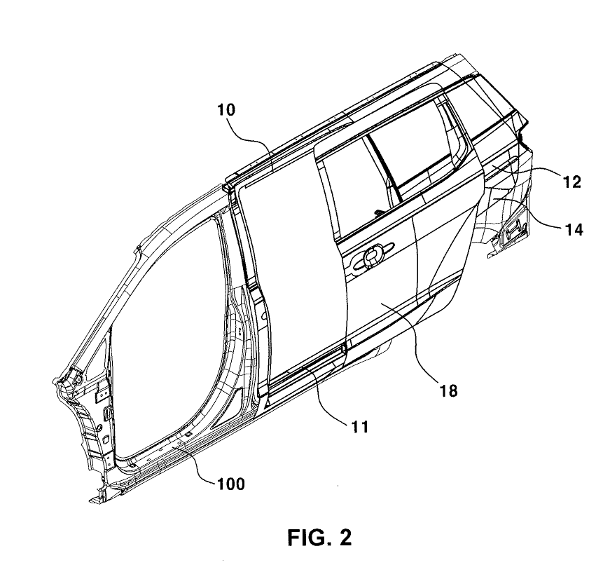

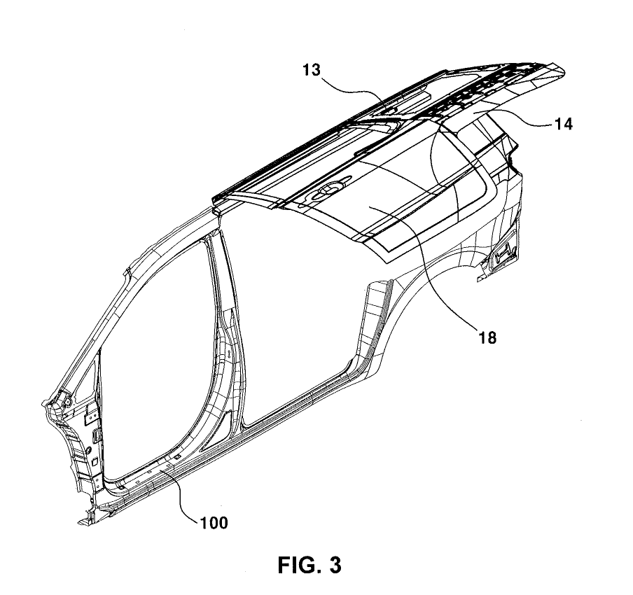

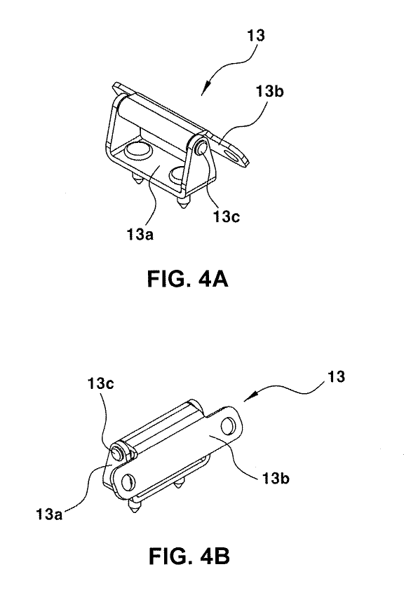

Herein, the hinge portion 13 is constituted by a fixed hinge bracket 13a and a rotational hinge bracket 13b, and a pin 13c connecting the fixed hinge bracket 13a and the rotational hinge bracket 13b as illustrated in FIG. 4A and FIG. 4B, and the fixed hinge bracket 13a and the rotational hinge bracket 13b are fixed to the vehicle body and onto an inner surface of the upper end portion of the gull wing door 14, respectively in a fastening structure.

The gull wing door 14 may have a form to include a space part which is opened/closed by the slide door 18 and a passenger may get in or out of and a panel part which may finish a part of a vehicle body side.

Of course, the gull wing door 14 may have a handle assembly for opening/closing the door at one side of a front surface, for example, a lower end side of the front surface thereof.

Further, an upper rail 10, a lower rail 11, and an intermediate rail 12 are installed at the upper end portion, the lower end portion, and the intermediate portion of the gull wing door 14 in parallel in a horizontal length direction and an upper roller assembly 15, a lower roller assembly 16, and an intermediate roller assembly 17 to be described below move on the upper rail 10, the lower rail 11, and the intermediate rail 12 installed as above, and as a result, the slide door 18 may be opened/closed.

In particular, the upper and lower rails 10 and 11 and the intermediate rail 12 have a long channel form having a “C”-shaped cross-section an in this case, the upper rail 10 is deployed in line in a longitudinal direction along the inside of an upper end portion of the gull wing door 14, the lower rail 11 is deployed in line in the longitudinal direction along the inside of a lower end portion of the gull wing door 14, and the intermediate rail 12 is deployed in line in the longitudinal direction along the outside of the intermediate portion of the gull wing door 14.

As a result, since a package of an upper rail and a lower rail of the existing slide door occupy a large space, the existing slide door has a spatial limit, while since the upper and lower rails 10 and 11 and the intermediate rail 12 having a simple structure installed at the rail, that is, the gull wing door side do not occupy a large space, the gull wing door has an advantage in that there is a small spatial limit.

The slide door 18 as a door opened/closed in the horizontal direction is installed in a structure in which the slide door 18 is slide-joined to ten upper and lower and intermediate rails 10, 11, and 12 of the gull wing door 14 by using the upper roller assembly 15, the lower roller assembly 16, and the intermediate roller assembly 17 positioned at the upper end portion, the lower end portion, and the intermediate portion.

As a result, the slide door 18 may be opened/closed in the horizontal direction while being guided by the upper roller assembly 15, the lower roller assembly 16, and the intermediate roller assembly 17 that move along the upper rail 10, the lower rail 11, and the intermediate rail 12 of the gull wing door side.

Of course, the slide door 18 may have a handle assembly for opening/closing the door at an intermediate portion of a front surface thereof.

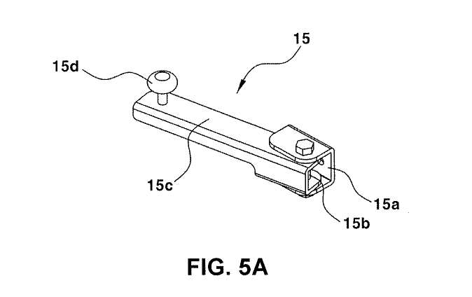

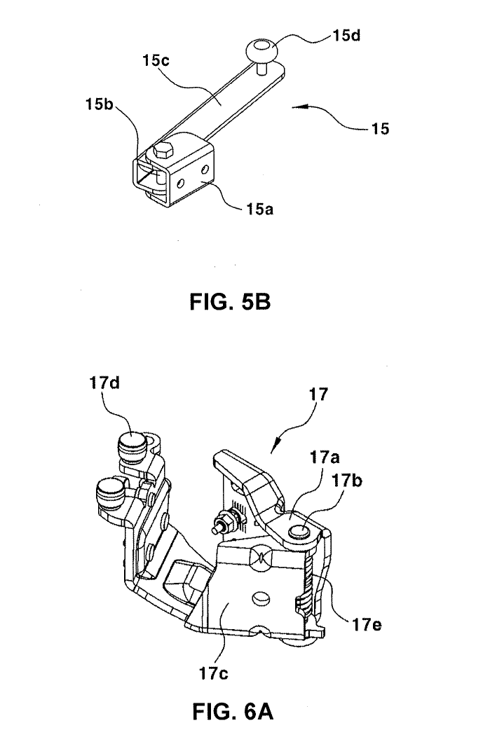

FIG. 5A and FIG. 5B are perspective views illustrating an upper roller assembly of the slide door in the gull wing door with the slide door according to various embodiments of the present invention.

As illustrated in FIG. 5A and FIG. 5B, herein, a structure of the upper roller assembly 15 supporting an upper side of the door at the time of opening/closing the slide door 18 is shown. To this end, an upper fixed bracket 15a having a “C”-shape is installed on the inside of the upper end portion of the slide door 18 in a fastening structure and a rear end portion of an upper roller arm 15c having a long bar shape is coupled to the upper fixed bracket 15a installed as above by an upper hinge pin 15b. Accordingly, the upper roller arm 15c rotates around the upper hinge pin 15b.

In addition, an upper roller 15d that moves while fitting in the upper rail 10 at the gull wing door side is mounted on a front end portion of the upper roller arm 15c.

As a result, an upper side of the slide door 18 may be supported while being guided by the upper roller 15d that moves along the upper rail 10 at the time of opening/closing the door.

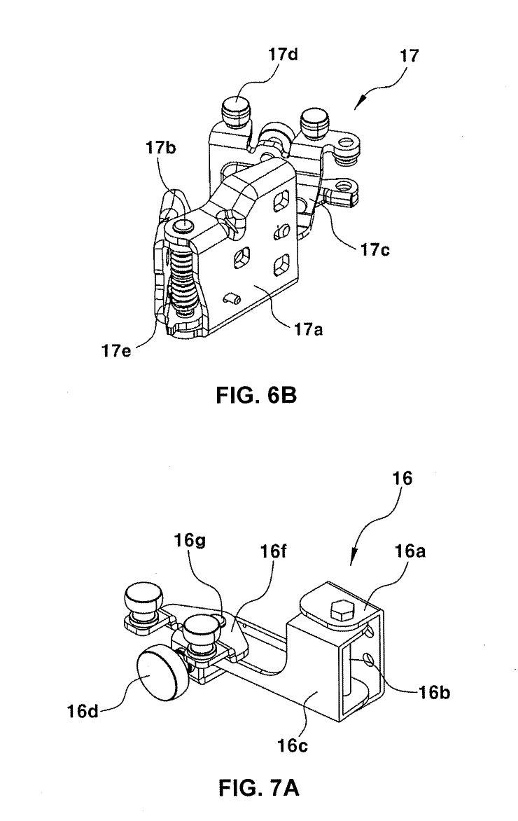

FIG. 6A and FIG. 6B are perspective views illustrating an intermediate roller assembly of the slide door in the gull wing door with the slide door according to various embodiments of the present invention.

As illustrated in FIG. 6A and FIG. 6B, herein, the intermediate roller assembly 17 supporting an intermediate side of the door at the time of opening/closing the slide door 18 is shown. To this end, an intermediate fixed bracket 17a having the “C”-shape is installed on the inside of the intermediate portion of the slide door 18 in the fastening structure and a rear end portion of an intermediate roller arm 17c in which a fin fastening portion and a roller mounted portion are integrated is coupled to the intermediate fixed bracket 15a by an intermediate hinge pin 17b. Accordingly, the intermediate roller arm 17c rotates around the intermediate hinge pin 17b.

In addition, an intermediate roller 17d that moves while fitting in the intermediate rail 12 at the gull wing door side is mounted on a front end portion of the intermediate roller arm 17c.

In this case, the intermediate roller 17d may be configured by a combination of at least three rollers that roll while contacting a horizontal surface and a vertical surface of the rail.

In particular, an intermediate spring 17e is mounted on the periphery of the intermediate hinge pin 17b and both end portions of the intermediate spring 17e at that time are suspended on the intermediate fixed bracket 17a and the intermediate roller arm 17c, respectively.

Herein, the intermediate spring 17e maintains a compression state when the door is closed and serves to widen the intermediate fixed bracket 17a and the intermediate roller arm 17c from each other while being expanded when the door is opened and consequently, the slide door 18 may be opened/closed while maintaining a predetermined interval from a gull wing door panel surface and a vehicle body panel surface by spring force.

As a result, an intermediate side of the slide door 18 may be supported while being guided by the intermediate roller 17d that moves along the intermediate rail 12 at the time of opening/closing the door.

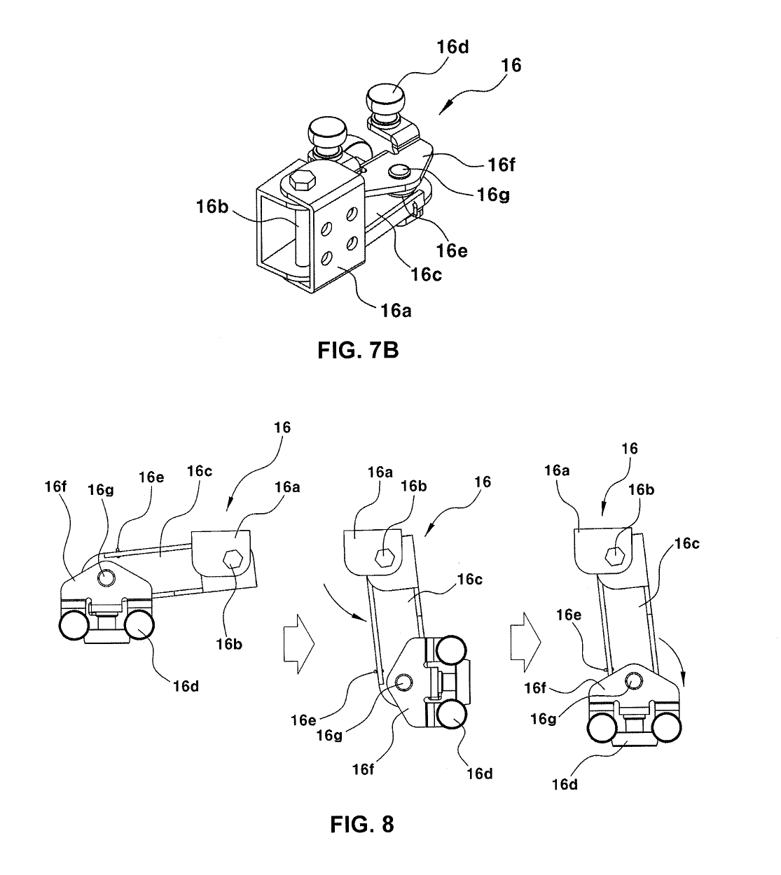

FIG. 7A and FIG. 7B are perspective views illustrating a lower roller assembly of the slide door in the gull wing door with the slide door according to various embodiments of the present invention.

As illustrated in FIG. 7A and FIG. 7B, herein, the lower roller assembly 16 supporting a lower side of the door at the time of opening/closing the slide door 18 is shown. To this end, a lower fixed bracket 16a having the “C”-shape is installed on the inside of the lower end portion of the slide door 18 in the fastening structure and a rear end portion of a lower roller arm 16c having an “L” shape is coupled to the lower fixed bracket 16a installed as above by a lower hinge pin 16b. Accordingly, the lower roller arm 16c rotates around the lower hinge pin 16b.

Further, a lower roller link member 16f having a “C”-shaped cross-section is fastened to the front end portion of the lower roller arm 16c by a lower second hinge pin 16g and the lower roller link member 16f at that time may rotate around the lower second hinge pin 16g.

In particular, a lower spring 16e is mounted on the periphery of the lower second hinge pin 16g and both end portions of the lower spring 16e at that time are suspended on the lower roller arm 17c and the lower roller link member 16f, respectively.

In this case, the lower spring 16e elastically supports the entirety of the lower roller link member 16f including the lower roller 16d, and as a result, while the entirety of the lower roller link member 16f including the lower roller 16d rotates by receiving the spring force in the state in which external force is not applied (door opened state), the entirety of the lower roller link member 16f may be deployed in line at a front end side of the arm.

In addition, the lower roller 16d that moves while fitting in the lower rail 11 at the gull wing door side is mounted on the front end portion of the lower roller arm 16c.

In this case, the lower roller 16d may be configured by a combination of at least three rollers that roll while contacting the horizontal surface and the vertical surface of the rail.

As a result, a lower side of the slide door 18 may be supported while being guided by the lower roller 16d that moves along the lower rail 11 at the time of opening/closing the door.

FIG. 8 is a plan view illustrating an operational state of the lower roller assembly of the slide door in the gull wing door with the slide door according to various embodiments of the present invention.

As illustrated in FIG. 8, herein, an operational flow of the lower roller assembly 16 at the time of opening/closing the slide door 18 is shown.

While the slide door 18 is closed, the lower roller link member 16f including the lower roller 16d is positioned on the side of the front end portion of the lower roller arm 16c.

In this state, when the slide door 18 is opened, the lower roller arm 16c that is folded by the motion of the slide door 18 which is slightly pushed outside (by expansion force of an intermediate spring positioned in the intermediate roller assembly) is unfolded and the lower roller link member 16f including the lower roller 16d rotates around the lower second hinge pin 16g (alternatively, the lower roller arm relatively rotates) by receiving restoration force of the compressed lower spring 16e to be positioned in line in front of the front end portion of the lower roller arm 16c.

As a result, when the door is opened, the slide door 18 may maintain a gap from the vehicle body 100 while moving along the rail and when the door is closed, a stop suspension jaw is provided on the rail at a predetermined position, and as a result, the lower roller arm 16c and the lower roller link member 16f of the lower roller assembly 17 are folded. Therefore, the door may be closed while the door is seated on the vehicle body 100.

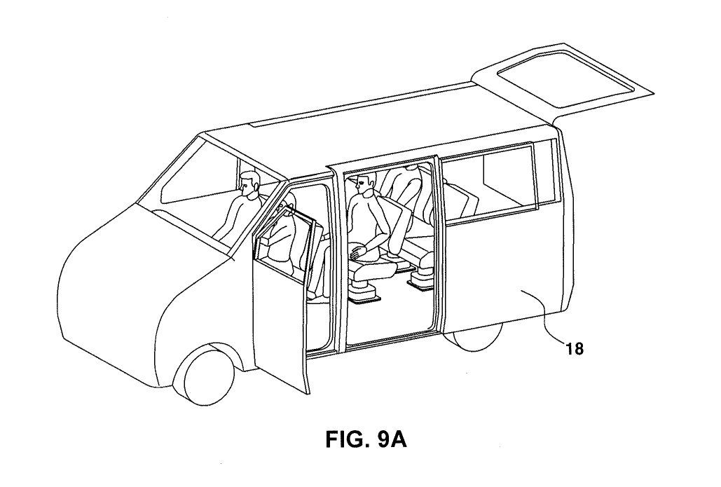

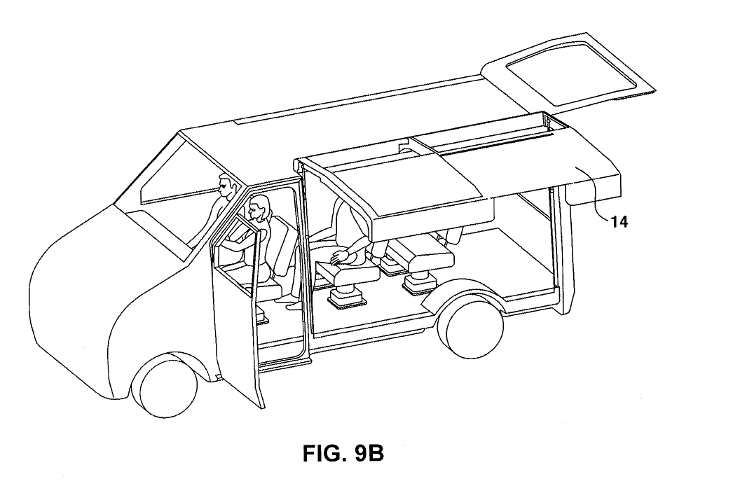

FIG. 9A and FIG. 9B are perspective views illustrating an application example of the gull wing door with the slide door according to various embodiments of the present invention.

As illustrated in FIG. 9A and FIG. 9B, getting on or off may be performed by only the slide door 18 similarly as usually while the gull wing door 14 is closed.

In addition, since a door opening area may be widely secured by bending back the gull wing door 14 upward and opening the gull wing door 14 while the slide door 18 is closed at the time of loading the large burden or getting on or off the vehicle, the large burden may be easily loaded and the getting-on or off may also be conveniently performed.

For convenience in explanation and accurate definition in the appended claims, the terms “upper” or “lower”, “inner” or “outer” and etc. are used to describe features of the exemplary embodiments with reference to the positions of such features as displayed in the figures.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A gull wing door with a slide door for a vehicle, comprising:
a gull wing door including an upper rail, a lower rail, and an intermediate rail in line at an upper end portion, a lower end portion, and an intermediate portion in a horizontal length direction and supported on a vehicle body by a hinge portion positioned at the upper end portion and openable/closable in a vertical direction about the hinge portion; and
a slide door including upper and lower portions and an intermediate portion of the gull wing door at an upper end portion and a lower end portion, and a middle portion and openable/closable in a horizontal direction while being supported on the gull wing door by upper and lower rollers and an intermediate roller assembly.

2. The gull wing door of claim 1, wherein the upper rail provided in the gull wing door is configured to be deployed in line in a longitudinal direction along an inside of the upper end portion of the door, the lower rail is configured to be deployed in line in the longitudinal direction along an inside of the lower end portion of the door, and the intermediate rail is configured to be deployed in line in the longitudinal direction along an outside of the intermediate portion of the door.

3. The gull wing door of claim 1, wherein the upper roller assembly provided in the slide door includes:
an upper fixed bracket fixed to the slide door;
an upper roller arm, in which a rear end portion is rotatably supported on the upper fixed bracket by an upper hinge pin; and
an upper roller configured to roll along the upper rail while being mounted on a front end portion of the upper roller arm.

4. The gull wing door of claim 1, wherein the lower roller assembly provided in the slide door includes:
a lower fixed bracket fixed to the slide door;
a lower roller arm, in which a rear end portion is rotatably supported on the lower fixed bracket by a lower hinge pin;
a lower roller link member rotatably supported on a front end portion of the lower roller arm by a lower second hinge pin; and
a plurality of lower rollers configured to roll along the lower rail while being mounted on the lower roller link member.

5. The gull wing door of claim 4, wherein the lower roller assembly further includes a lower spring in which both ends are supported on a lower roller arm and the lower roller link member while surrounding the second hinge pin to elastically support the entirety of the lower roller link member including the lower roller.

6. The gull wing door of claim 1, wherein the intermediate roller assembly provided in the slide door includes an intermediate fixed bracket fixed to the slide door, an intermediate roller arm, in which a rear end portion is rotatably supported on the intermediate fixed bracket by an intermediate hinge pin, and a plurality of intermediate rollers that are configured to roll along the intermediate rail while being mounted on a front end portion of the intermediate roller arm.

7. The gull wing door of claim 6, wherein the intermediate roller assembly further includes an intermediate spring in which both ends are supported the intermediate fixed bracket and the intermediate roller arm while surrounding the intermediate hinge pin to elastically support the entirety of the intermediate roller arm including the intermediate roller.

8. The gull wing door of claim 1, wherein the lower roller assembly further includes a lower spring in which both ends are supported on a lower roller arm and the lower roller link member while surrounding the second hinge pin to elastically support the entirety of the lower roller link member including the lower roller.

9. The gull wing door of claim 1, wherein the intermediate roller assembly further includes an intermediate spring in which both ends are supported the intermediate fixed bracket and the intermediate roller arm while surrounding the intermediate hinge pin to elastically support the entirety of the intermediate roller arm including the intermediate roller.
